(19) United States
(12) Patent Application Publication
(10) Pub. No.: US 2005/0201825 A1
(43) Pub. Date: Sep. 15, 2005

(54) Clamping device for releasably clamping a cylindrical hub in place on a cylindrical shaft

(76) Inventor: Roland Zingeler, Leipzig (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/075,507

(22) Filed: Mar. 9, 2005

(30) Foreign Application Priority Data
Mar. 10, 2004 (DE) 10 2004 011 679.2

(51) Int. Cl. F16D 3/14

(52) U.S. Cl. 403/367

(57) ABSTRACT

The invention relates to a clamping device for releasably clamping a cylindrical hub in place on a cylindrical shaft, in particular a centrifuge rotor on a cylindrical shaft, having two clamping elements (2, 4) coiled in a helical spring shape, the coils of one clamping element, in cross section through a plane containing the helix longitudinal axis, being provided with a wedge-shaped bevel (3) on one side with regard to the helix turn direction, and the coils of the other clamping element, in said cross section, being provided with a complementary bevel (5) on the other side with regard to the helix turn direction, this bevel (5) facing the bevel (3) of the first clamping element (2), so that the bevels (3, 5), when a compressing force acts on the clamping elements, are pushed one on top of the other in order to produce a radially inwardly directed and outwardly directed expansion of the clamping elements (2, 4) for frictionally clamping the shaft in place in the hub.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention relates to a clamping device for releasably clamping a cylindrical hub in place on a cylindrical shaft, in particular a centrifuge rotor on a cylindrical shaft.

Conical receptacles and conical shaft pieces, for example, have been used hitherto for the releasable fastening of a centrifuge rotor to a cylindrical shaft, but seizing or “sticking” of the centrifuge rotor on the shaft may occur in the case of said conical receptacles and conical shaft pieces. The hitherto known cylindrical receptacles or hubs for centrifuge rotors require a driver pin, which is inserted radially through the shaft and weakens the shaft in this region.

“Clamping sleeves” are generally known as clamping connections of hubs on shafts. These clamping sleeves consist of two annular parts which have a bevelled wedge shape in cross section perpendicularly to the ring plane, one ring part having a bevel on the outside and the other having a complementary bevel on the inside, so that the ring parts can be pushed one inside the other when the bevels face one another. When an axial force is exerted on the clamping sleeve, the two ring parts are pushed one inside the other, in the course of which the complementary bevels produce a clamping effect and a radially inwardly directed and outwardly directed force for frictionally clamping the shafts of the hub in place. In the case of these clamping sleeves, it is desirable, for permanent clamping, for the sleeve parts to also be plastically deformed when being pushed one over the other in order to achieve reliable clamping. Therefore soft metal alloys are used for these clamping sleeves. However, this shaft-hub connection is disadvantageous in various respects. Firstly, it cannot be readily released again. Furthermore, the clamping connection is concentrated on the relatively short region of a clamping sleeve in the axial direction, for it is not possible in a hypothetical arrangement of a plurality of clamping sleeves at an axial distance from one another for all the clamping sleeves lying one behind the other to be pushed one on top of the other and clamped in place by an externally acting compressing force on these clamping sleeves, so that the inner clamping sleeves remain loose and do not contribute to the clamping. The clamping effect of such clamping sleeves is therefore relatively small.

DE 34 11 230 A1 discloses a clamping sleeve consisting of two sleeves connected via a thread. The thread is saw-tooth-shaped in cross section with a flat rising angle of the rising saw-tooth flank. The clamping effect is achieved by mutual axial pushing of both sleeves by displacing the inclined flanks of the thread relative to one another.

U.S. Pat. No. 4,514,109 A describes a clamping device for a sleeve on a hub, a helical spring being arranged in the intermediate space between hub and sleeve coaxially to them. Furthermore, means for axially compressing the helical spring are provided. The axial compression of the helical spring causes adjacent coils to be pressed against one another, the coils being partly pushed axially one over the other, which produces a radially inwardly directed and outwardly directed expansion of the helical spring and frictional contact between the hub and the sleeve.

U.S. Pat. No. 1,938,099 A describes a clamping spring which has two helical springs—an inner and an outer helical spring—arranged coaxially to one another. The coils of the inner spring, in cross section through a plane containing the helix longitudinal axis, have surfaces falling away radially from the centre to the sides. The outer helical spring has coils which, in said cross section, are bevelled on the inside so as to widen radially from the centre outwards towards both margins. The bevels of the inner and outer helical springs are in contact with one another, thereby resulting in the bevels being pushed one over the other when the spring arrangement is compressed, which produces forces inwards and outwards in the radial direction.

U.S. Pat. No. 2,709,607 A describes a clamping spring device having an inner and an outer helical spring. The coils of the inner and outer helical springs are triangular in cross section through a plane containing the helical-spring longitudinal axes, the tips of the triangles of the inner helical spring being directed outwards and those of the outer helical spring being directed inwards. The bevels of the coils triangular in cross section come into contact with one another when the spring arrangement is axially compressed, further axial compression leading to displacements of the bevels relative to one another and thus leading to radial expansion of the spring arrangement until adjacent coils of the inner spring come into contact with their corners, and accordingly the corners of adjacent coils of the outer spring come into contact, after which compressibility is no longer provided for.

The object of the present invention is to provide a clamping device for clamping a cylindrical hub in place on a cylindrical shaft, which clamping device can be easily released and with which a firm driving fit for transmitting high driving and braking torque can be achieved.

### BACKGROUND OF THE INVENTION

The clamping device has two clamping elements coiled in a helical spring shape. The coils of the clamping elements have wedge-shaped bevels in cross section through a plane containing the helix longitudinal axis, these bevels being arranged in such a way that the wedge-shaped bevel of one clamping element is directed towards that of the other clamping element and in a complementary manner to the latter, so that the bevels, when a pushing-together force acts on the clamping elements in the helix longitudinal direction, are pushed one on top of the other in order to produce a radially inwardly and outwardly directed force for expanding the clamping elements for frictionally clamping the shaft in place in the hub. Due to the geometry of the coils together with the elastic restoring effect of the spring clamping elements, the clamping device can easily be released by the compression of the clamping device being neutralized in the helix longitudinal axis direction, after which the clamping spring elements expand again and the bevels slide apart, so that the clamping radial forces between shaft and hub fall away. The clamping device sits with one end on a shoulder of the shaft and is preferably covered at its opposite end by a fixing ring, which is adjustable in the axial direction and can be secured in a desired position in order thus to secure the clamping spring elements with a desired compression in the intermediate space between shaft and hub.

During the compression of the clamping device, the bevels, directed towards one another, of the clamping springs convert a force exerted on the clamping device in the helix longitudinal direction into forces directed radially inwards and outwards, which results in the shaft being frictionally secured in the hub, this force directed inwards and outwards being distributed over the entire axial length of the clamping springs, so that clamping over a large area is achieved. Furthermore, driving torque and braking torque can help to further increase the driving fit by turning the clamping springs tightly into one another.

### BRIEF DESCRIPTION OF THE SEVERAL VIEWS OF THE DRAWINGS

The invention is described below with reference to an exemplary embodiment in connection with the drawing, in which:

FIG. 1 shows a lateral plan view of two helical-spring-shaped clamping elements,

FIG. 2 shows a cross-sectional view of the clamping element taken along the plane indicated by the arrows B in FIG. 1,

FIG. 3 shows an enlarged detail of the cross-sectional view of the clamping elements from FIG. 2,

FIG. 4 shows a schematic overall view of a shaft/hub connection in cross section, and

FIG. 5 shows an enlarged detail of the cross-sectional view from FIG. 4.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

FIG. 1 shows a plan view of two helical-spring clamping elements 2 and 4 pushed one inside the other. The coils of the spring clamping elements consist of band-shaped metal strips which, in cross section through a plane containing the helix longitudinal axis (connecting line between the arrows B), have a bevel on opposite sides with regard to the helix turn direction, the bevels facing one another and being shaped so as to be complementary to one another.

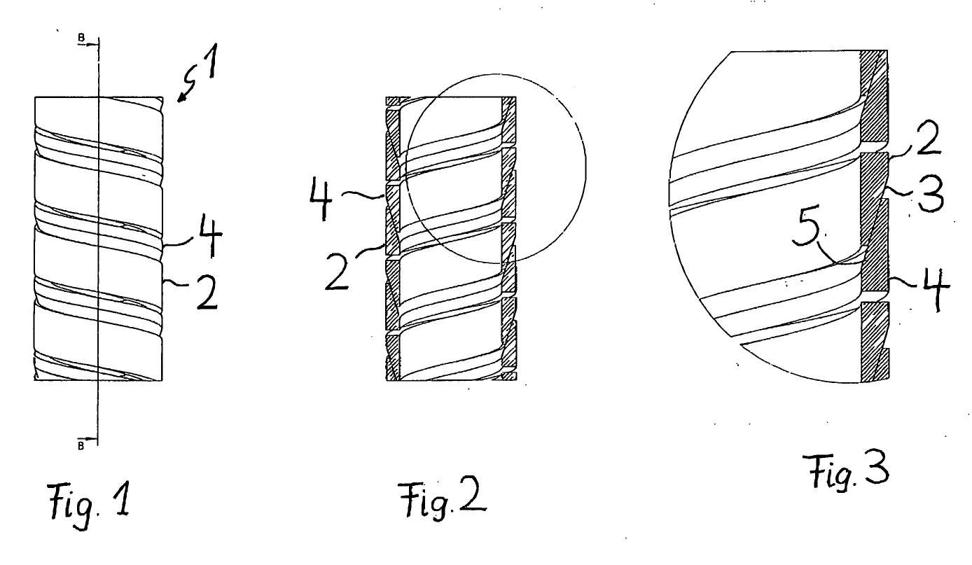

In the illustration of FIG. 3, the bevel 3 of the spring clamping element 2 is shown on the bottom side and runs from the outside inwards, whereas the bevel 5 of the spring clamping element 4 lies on the top side of the clamping element and runs outwards, so that the bevels 3 and 5 can be pushed one over the other in a wedge-like manner.

It can be seen from the illustrations of FIGS. 2 and 3 that, if a force compressing the screw-shaped spring clamping elements is exerted in the axial direction, the spring clamping elements 2 and 4 are compressed (in the axial direction) and the bevels 3 and 5 can be pushed further one over the other, so that resulting forces are produced inwards and outwards in the radial direction.

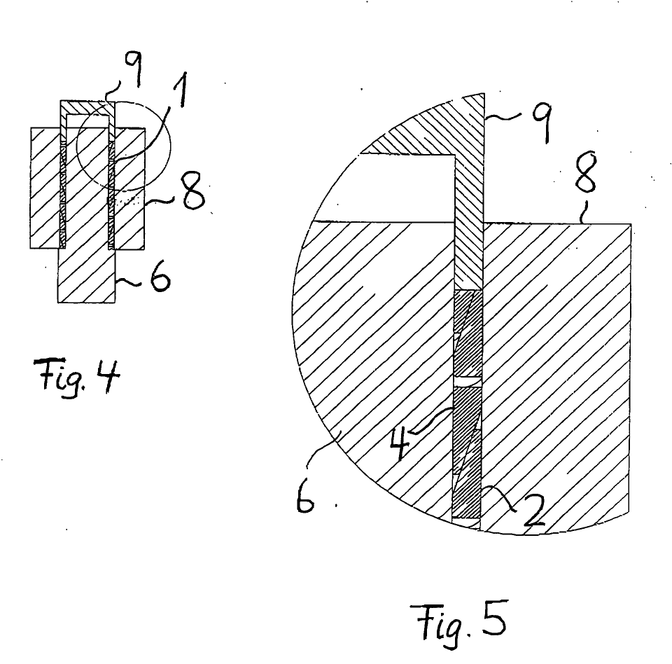

The arrangement of the clamping device 1 in connection with a shaft 6 and a hub 8 can be seen from the overall illustration in FIG. 4. The clamping device 1 with its two spring clamping elements 2 and 4 sits in the annular clearance space provided between the shaft 6 and the hub 8. At the bottom, the clamping device 1 sits on a shoulder of the shaft 6, whereas a cap-shaped fixing ring 9 is inserted from above into the annular intermediate space between the hub and the shaft, so that it sits with its bottom margin on the top of the clamping device 1. The fixing ring 9 can be secured in a desired axial position with regard to the clamping device 1 by mechanisms which are not shown in any more detail, so that a desired compression of the clamping device 1 in the axial direction can be produced.

As can be seen from FIG. 5, lowering of the fixing ring 9 leads to the spring clamping elements 2 and 4 being compressed and being pushed one over the other with their bevels, from which forces directed radially inwards and outwards are produced along the entire clamping device 1, these forces providing for frictional securing of the hub 8 on the shaft 6.

The spring clamping elements 2 and 4 are preferably made of high-grade steel. Plastic deformability especially, unlike in the case of the known clamping sleeves, is not desired. On the contrary, the elastically flexible effect is advantageous in connection with the present invention.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. Clamping device for releasably clamping a cylindrical hub in place on a cylindrical shaft, in particular a centrifuge rotor on a cylindrical shaft, having two clamping elements (2, 4) coiled in a helical spring shape, the coils of one clamping element, in cross section through a plane containing the helix longitudinal axis, being provided with a wedge-shaped bevel (3) on one side with regard to the helix turn direction, and the coils of the other clamping element, in said cross section, being provided with a complementary bevel (5) on the other side with regard to the helix turn direction, this bevel (5) facing the bevel (3) of the first clamping element (2), so that the bevels (3, 5), when a compressing force acts on the clamping elements, are pushed one on top of the other in order to produce a radially inwardly directed and outwardly directed expansion of the clamping elements (2, 4) for frictionally clamping the shaft (6) in place in the hub (8).

2. Clamping device according to claim 1, the first and second clamping elements being made of high-grade steel.

3. Clamping device according to claim 1, the angle of the bevels (3, 5) of the clamping elements relative to the longitudinal axis direction being within the range of 20° to 50°.

4. Clamping device according to claim 2, the angle of the bevels (3, 5) of the clamping elements relative to the longitudinal axis direction being within the range of 20° to 50°.
